(19) United States
(12) Patent Application Publication
(10) Pub. No.: US 2002/0163749 A1
(43) Pub. Date: Nov. 7, 2002

(54) ADR system

(76) Inventor: Joannes Godefridus, M. van Thuijl, Veldhoven (NL)

Correspondence Address: Michael B. Lasky, Altera Law Group, Suite 100, 6500 City West Parkway, Minneapolis, MN, 55344-7701, US

(21) Appl. No.: 10/103,176

(22) Filed: Mar. 20, 2002

Related U.S. Application Data
(63) Continuation of application No. PCT/NL00/00676, filed on Sep. 22, 2000.

(30) Foreign Application Priority Data
Sep. 22, 1999 (NL) 1013117

(51) Int. Cl. G11B 5/03; G11B 5/035

(52) U.S. Cl. 360/66; 360/65

(57) ABSTRACT

An ADR (advanced digital recording) system for reading and writing information on a magnetic tape using a thin film head (1) with a read part and a write part, whereby track sensing signals on the tape can be read out and data signals can be written on the tape and read out, comprises a preamplifier (2) and, connected thereto, readout channels (3, 4) for track sensing signals and data signals, as well as a low pass filter for the track sensing signals. Both the channel separation for track sensing signals and data signals and the filtering of track sensing signals take place in the preamplifier (7, 8) provided on an IC.

The present invention relates to an ADR (advanced digital recording) system for reading and writing information on a magnetic tape using a thin film head with a read part and a write part, whereby track sensing signals on the tape can be read out and data signals can be written on the tape and read out, which ADR system comprises a preamplifier and, connected thereto, readout channels for track sensing signals and data signals, as well as a low pass filter for the track sensing signals.

The track sensing signals are stored deeply in the magnetic tape and contain information that is of importance for the positioning and the servo control of the film head with respect to the tape and the time control signals needed. The data signals have been, or are, stored closely under the surface of the tape and contain read data signals which are read from the tape and write data signals which are provided by a processing IC in order to be written on the tape. In a read mode, track sensing signals and data signals on the tape are read out. In a write mode, track sensing signals on the tape are read out and data signals are written on the tape. In a read/write mode, track sensing signals on the tape are read out, data signals are written on the tape and also, in particular for verification purposes, read out. In the latter case, two physically separate film heads will be present, one being active in the read mode and the other in the write mode, while the head which is active for writing data signals on the tape is also active for reading out track sensing signals from the tape.

Both in the write mode and the read/write mode, data signals are written during the readout of track sensing signals, and because this is done with the same film head, crosstalk will occur. In particular, this involves problems associated with the fact that the signal strength of the track sensing signals to be read out differs strongly from that of the data signals to be written; the strength of the track sensing signals is typically in the order of 1 mVpp, while that of the data signals is in the order of 1.2 Vpp. The track sensing signals to be read out and the data signals read out simultaneously therewith owing to crosstalk are passed to a preamplifier IC; these signals, due to the strong crosstalk signals, are limited in the preamplifier, so that track sensing information may be lost.

To solve this problem, it has previously been proposed to prevent the clipping that occurs in the preamplifier by including a low pass filter between the film head and the preamplifier IC in the read mode and the read/write mode. As the bandwidth of the track sensing signals is typically in the order of 500 Hz to 10 kHz, and that of the data signals is in the order of 1.5 kHz to a few MHz, it is thus possible to obtain a separation of track sensing signals and data signals present due to crosstalk. The data signals present due to crosstalk are suppressed, while the track sensing signals are passed and amplified. Switching-on of the low pass filter at the input of the preamplifier is controlled by a write control signal (write-enable signal WrEn) which becomes active when the write mode is activated.

As the ohmic resistance of a thin film head is in principle less than 100Ω and the input resistance of the preamplifier is greater than 1.5 kΩ, the capacitor, to effect the desired filtering, must have such a large capacitance (in the order of 1 μF) that it cannot efficiently be integrated on an IC together with the preamplifier. An impedance increase between the head and the input resistance to thereby obtain a lower value for the capacitance is conceivable, but leads to a deterioration of the signal to noise ratio, since an impedance increase leads to stronger noise. For that matter, the attenuation caused by the impedance increase can be compensated by a greater amplification.

The disadvantage of the above, known solution, whereby the low pass filter is abruptly switched on and off, is that an “offset” voltage jump is introduced into the preamplifier. This offset voltage jump can disturb zero crossings in the track sensing signal with the result that time control errors and errors in the servo control of the tape occur. Further, the necessity of including components needed to realize the low pass filter, outside of the preamplifier present in IC form means that this solution is relatively expensive.

The object of the invention is to remove the problems mentioned, at least to limit them to a considerable extent, and to provide an ADR system, in which, in an efficient manner and in IC form, the track sensing signals on the one hand and the data signals present during writing (in the write mode or in the read/write mode) due to crosstalk and the “useful” data signals read out at readout (in the read mode) on the other, can be separated from each other. In the following, for the sake of brevity, reference will be made to the separation of track sensing signals and data signals.

According to the invention, to that end, the ADR system such as it is described in the opening paragraph hereof is characterized in that both the channel separation for track sensing signals and data signals and the filtering of track sensing signals take place in the preamplifier provided on an IC. This means in particular that during the readout of track sensing signals in the write mode or in the read/write mode, it is in the preamplifier, i.e., in IC form, that the signals as read are filtered and separated from the data signals read out simultaneously due to crosstalk.

In particular, the preamplifier comprises an emitter amplifier with a collector resistance (resistor R_{L}) and a cascode stage included in the collector circuit, while between the collector and the base of the cascode stage a decoupling circuit is present, which provides that the output voltage of the emitter amplifier exhibits a low pass characteristic, whereby it is also accomplished that the additional noise contribution which is caused by the decoupling circuit is negligible.

Through this measure, it appears that, given a suitable dimensioning of the decoupling circuit, a low pass characteristic can be obtained at the output of the emitter amplifier, while the capacitance can be chosen to be so small that a design thereof in IC form is rendered possible. Although the decoupling circuit will cause an additional noise contribution at the output of the emitter amplifier with respect to the output at the collector resistor, this additional noise contribution is virtually negligible with respect to the noise caused by the magnetic tape and the film head.

The output of the emitter amplifier provides track sensing signals and the output voltage at the collector of said transistor data signals.

It should be noted that the cascode stage can be formed by one or more transistors or by one or more FETs. Where reference is made to a transistor, this should be understood to encompass a FET; naturally, the words collector, base and emitter are then to be understood to mean drain, gate and source.

In addition to an implementation in IC form now being possible, the ADR system according to the invention has the further advantage that no write control signal, such as the WrEn signal in the prior art, is needed anymore, so that no offset voltage jump with the associated disadvantages occurs. Owing to a saving on external components, that is, components not present in IC form, the manufacturing costs are lower.

Although filters of a higher order can be used, in a simple embodiment the cascode stage is formed by a transistor and the decoupling circuit by a feedback resistor (resistor R_{F}) arranged between the collector and the base of this transistor and a decoupling capacitor (capacitance C) linked to the base of the transistor.

In connection with an optimum voltage amplification, the emitter amplifier is formed by a single-stage grounded emitter amplifier, while the preamplifier further comprises a circuit for a dc setting of the base of the emitter amplifier.

Through a proper dimensioning, it is rendered possible to give the output voltage TS of the emitter amplifier, with respect to the input voltage Vᵢ thereof, a transfer characteristic which, in approximation, can be represented by:

$$\frac{TS}{{V}_{i}} = - {g}_{M1} * {R}_{L} * \frac{1}{1 + jω C ( {R}_{F} + {R}_{L} )}$$

and to give the output voltage DATA at the collector of said transistor, with respect to said input voltage Vᵢ, a transfer characteristic which, in approximation, can be represented by:

$$\frac{DATA}{{V}_{i}} = - {g}_{M1} * {R}_{L}$$

wherein R_{F}>>R_{L} and (R_{F}+R_{L})>>1/g_{M1} and g_{M1} represents the inverse value of the intrinsic emitter resistance of the transistor in the single-stage grounded emitter amplifier. In other words, the amplification both of the track sensing signals and of the data signals is determined within the bandwidth in question by the factor g_{M1}*R_{L}, i.e., by the voltage amplification of the emitter amplifier. It is noted here that the transfer function for the data signals in said approximation is represented within the bandwidth for this channel, viz. a bandwidth of 1/g_{M2}, where g_{M2} represents the inverse value of the intrinsic emitter resistance of the transistor 8. This bandwidth, however, is considerably larger than that of the track sensing signals.

By choosing values, in the decoupling circuit, for R_{L} and R_{F} of, for instance, 2k7 and 330k, respectively, a capacitance of the decoupling capacitor C of about 22pF will suffice. Such a capacitance is easy to realize in IC form.

As already mentioned hereinbefore, filtering of the track sensing signals takes place in such a manner that, as a consequence, within the bandwidth of the track sensing signals an additional noise contribution is introduced, which is negligible with respect to the noise caused by the film head and the magnetic tape. In particular, the output of the emitter amplifier, with respect to the output on the collector resistor, will contain an additional noise contribution which is caused by the feedback resistor R_{F}. This additional noise contribution, when calculated back to the input of the emitter amplifier (equivalent voltage noise), can be represented in approximation by:

$$( \frac{{R}_{F}}{{R}_{L}} * \frac{1}{{g}_{M1}} ) \sqrt{\frac{4 kTB}{{R}_{F}}}$$

wherein k represents Boltzmann's constant, T the absolute temperature and B the noise bandwidth. This additional noise contribution in the output channel for the track sensing signals, given the chosen values for R_{L} and R_{F}, only leads to an absolute difference in noise in the order of 2 dB with respect to the output channel for the data signals. This is an altogether minor noise contribution with respect to the noise which is caused by the magnetic tape and the film head. The noise introduced by these is typically higher by 10 dB or more. The amplification of the track sensing signals (within the pass band) and the data signals, viz. g_{M1}*R_{L}, is in the order of 40 dB.

The invention will now be further explained with reference to the accompanying drawings. In the drawings:

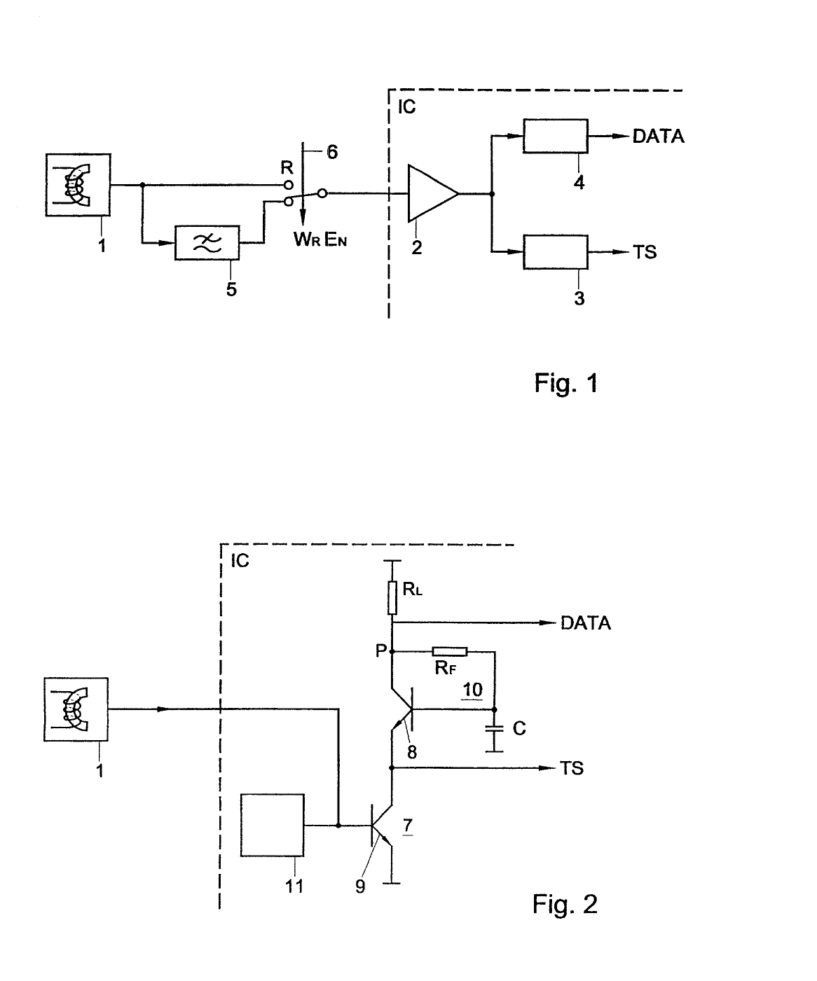

FIG. 1 schematically shows the low pass filter and the preamplifier according to the prior art; and

FIG. 2 schematically shows an embodiment of the preamplifier with input circuit according to the invention.

FIG. 1 shows a thin film head 1 and an IC including inter alia a preamplifier 2 and a reading channel 3 via which read-out track sensing signals (TS) are passed on and a reading channel 4 via which read-out data signals (DATA) are passed on. During readout of a tape, the information read out is passed directly from the film head 1 and the preamplifier 2 over either of the channels 3 or 4. In the write mode and the read/write mode, the track sensing signals are to be filtered because then, due to crosstalk, data signals are being read out at the same time. To that end, a low pass filter 5 is present, which, when a switch is made to the write mode or the read/write mode, is switched on via a switch 6 by a write enable signal WrEn. As already mentioned hereinbefore, such a filter technique already known is not satisfactory.

FIG. 2 shows a filter technique according to the invention, whereby on an Ill a channel separation for track sensing signals and for data signals is realized in the preamplifier itself, while at the same time the track sensing signals are filtered. The preamplifier arranged on an IC in FIG. 2 comprises an emitter amplifier 7 with a collector resistor R_{L} and a cascode stage, included in the collector circuit, in the form of a transistor 8 in cascode configuration. The emitter amplifier 7 is designed as a single-stage grounded emitter amplifier with a transistor 9. between the collector and the base of the transistor 8, a decoupling circuit 10 is present, which provides that the output voltage of the emitter amplifier 7 exhibits a low pass characteristic; accordingly, via this output the track sensing signals are delivered. At the collector output of the transistor 8, in the read mode, the data signals are delivered and in the read/write mode or—although not particularly relevant for practice—in the write mode during the readout of the track sensing signals the data signals present through crosstalk.

The decoupling circuit 10 is formed by a feedback resistor R_{F} arranged between the collector and the base of the transistor 8, and a decoupling capacitor C arranged between the base of this transistor and earth.

Because the dc setting of the cascode stage, i.e., of the transistor 8, occurs via the feedback resistor R_{F} from the nodal point P, the TS output 7 is less sensitive to overload of the transistor 9. The setting current of the transistor 8 is determined by the transistor 9; even if the collector of the cascode stage becomes saturated due to relatively large interference signals at the input (crosstalk), still a filtered and undistorted or substantially undistorted output signal TS can be obtained.

The signals of the thin film head 1 are supplied as input signals Vᵢ to the base of the transistor 9. The preamplifier includes a circuit 11 for a dc setting of the transistor 9.

The transfer functions of the preamplifier described here can be represented by the following relations:

$$\frac{TS}{{V}_{i}} = - {g}_{M1} * {R}_{L} * \frac{1}{1 + jω C ( {R}_{F} + {R}_{L} )}$$

$$\frac{DATA}{{V}_{i}} = - {g}_{M1} * {R}_{L}$$

It is noted here that the transfer function for the data signals is represented within the bandwidth for this channel, viz. a bandwidth of 1/g_{M2}, wherein g_{M2} represents the inverse value of the intrinsic emitter resistance of the transistor 8. This bandwidth, however, is considerably larger than that of the track sensing signals.

It appears from the relations shown that within the respective bandwidths the amplification is determined by the amplification factor of the emitter amplifier g_{M1}*R_{L}, while the track sensing signals TS have been subjected to a low pass filtering, while due to the relatively high values of R_{L} and R_{F} the capacitance C can be kept relatively low, at least with respect to the capacitance of the capacitor in the filter according to the prior art represented in FIG. 1, so that this capacitance can also be implemented in IC form.

The amplification of the data signals and—within the bandwidth of the low pass filter—the track sensing signals, with 1/g_{M1}=25 Ohm and R_{L,} as mentioned above, 2k7, equals about 100, that is, 40 dB.

When the additional noise contribution in the output for the track sensing signals by the low pass filter is taken into account, viz. a noise contribution calculated back to the input of the emitter amplifier:

$$( \frac{{R}_{F}}{{R}_{L}} * \frac{1}{{g}_{M1}} ) \sqrt{\frac{4 kTB}{{R}_{F}}} ,$$

then it holds, with k=1.38.10⁻²³ J/K°, T 300 K°, and assuming B is 1 Hz, that this additional noise contribution is about 0.67 nV/√Hz, which, over the entire bandwidth at the output of the emitter amplifier leads to a reduction of the absolute difference in noise by about 2 dB. The noise at the DATA output in this example is about 0.85 nV/√Hz, and at the TS output about [(0.85)²+(0.67)^{2]1/2}=1.1 nV/√Hz.

Finally, it should be pointed out that in particular a FET has good utility when the supply voltage is low. It is then possible to choose a higher value for R_{F} and a still lower value for the capacitance C.

1. An ADR (advanced digital recording) system for reading and writing information on a magnetic tape using a thin film head with a read part and a write part, whereby track sensing signals on the tape can be read out and data signals can be written on the tape and read out, which ADR system comprises a preamplifier and, connected thereto, readout channels for track sensing signals and data signals, as well as a low pass filter for the track sensing signals, characterized in that both the channel separation for track sensing signals and data signals and the filtering of track sensing signals take place in the preamplifier provided on an IC.

2. An ADR system according to claim 1, characterized in that the preamplifier comprises an emitter amplifier with a collector resistance (resistor R_{L}) and a transistor in cascode configuration, included in the collector circuit, while between the collector and the base of said transistor a decoupling circuit is present, which provides that the output voltage of the emitter amplifier exhibits a low pass characteristic and within the respective bandwidth hardly any additional noise is introduced by the decoupling circuit.

3. An ADR system according to claim 2, characterized in that the output of the emitter amplifier provides the track sensing signals and the output voltage at the collector of said transistor the data signals present through crosstalk.

4. An ADR system according to claim 2 or 3, characterized in that the decoupling circuit is formed by a feedback resistance (resistor R_{L}) arranged between the collector and the base of said transistor, and a decoupling capacitor (capacitance C) linked to the base of the transistor.

5. An ADR system according to any one of claims 2-4, characterized in that the emitter amplifier is formed by a single-stage earthed emitter amplifier, the preamplifier further comprising a circuit for a dc setting of the base of the emitter amplifier.

6. An ADR system according to claim 4 or 5, insofar as this claim refers back to claim 4, characterized in that the output voltage TS of the emitter amplifier, with respect to the input voltage Vᵢ thereof, has a transfer characteristic which can be represented in approximation by:
$$\frac{TS}{{V}_{i}} = - {g}_{M1} * {R}_{L} * \frac{1}{1 + jω C ( {R}_{F} + {R}_{L} )}$$
and the output voltage DATA at the collector of said transistor, with respect to said input voltage Vᵢ, has a transfer characteristic which can be represented in approximation by:
$$\frac{DATA}{{V}_{i}} = - {g}_{M1} * {R}_{L}$$
wherein R_{F}>>R_{L} and (R_{F}+R_{L})>>1/g_{M1} and g_{M1} represents the inverse value of the intrinsic emitter resistance of the transistor in the single-stage earthed emitter amplifier.
